(19) United States
(12) Patent Application Publication
(10) Pub. No.: US 2022/0009066 A1
(43) Pub. Date: Jan. 13, 2022

(54) SEPARATING DEVICE, MAGAZINE ATTACHMENT AND FASTENING SYSTEM

(71) Applicant: Hilti Aktiengesellschaft, Schaan (LI)

(72) Inventors: Christoph STUERTZEL, Sigmarszell (DE); Thomas FOSER, Balzers (LI); Cyrill BAUR, Wetzikon (CH); Michael RUHSTALLER, Galgenen (CH); Stefan ZIEGLER, Siebnen (CH)

(21) Appl. No.: 17/312,176

(22) PCT Filed: Nov. 20, 2019
(86) PCT No.: PCT/EP2019/081961

§ 371 Date: Jun. 9, 2021

(30) Foreign Application Priority Data
Dec. 10, 2018 (EP) 18211341.5

(51) Int. Cl. B25C 1/00

(52) U.S. Cl. CPC B25C 1/003

(57) ABSTRACT

A separating device for separating a fastening element from a fastening element strip is provided, having a receptacle, in which the fastening element is received, wherein the fastening element defines a fastening direction, in which the fastening element is provided for being driven into an underlying surface; a transfer channel for transfer of the fastening element strip in a transfer direction, wherein the transfer channel has a separating section; a stop element, which has a stop position, in which the stop element projects into the transfer channel and forms a stop for the fastening element in the transfer direction when the fastening element is arranged in the separating section; and a passage position, in which the stop element is arranged outside the transfer channel and allows movement of the fastening element beyond the separating section in the transfer direction.

The invention relates to a separating device, to a magazine attachment having a separating device of this kind, and to a fastening system having a driving device and a magazine attachment of this kind.

Fastening elements, e.g. screws or nails, which are stored in a fastening element strip, are usually separated from the fastening element strip during the process of being driven into an underlying surface by a driving device. There are known separating devices in which the fastening element strip is transferred in a transfer direction until a fastening element is arranged in a separating section. However, the separating process may be impaired if the fastening element comes to a halt in front of or behind the separating section.

It is an object of the invention to make available a separating device, a magazine attachment and a fastening system by means of which a frictionless separating process is ensured in each case.

The object is achieved by a separating device for separating a fastening element from a fastening element strip, having a receptacle, in which the fastening element is received, wherein the fastening element defines a fastening direction, in which the fastening element is provided for the purpose of being driven into an underlying surface, having a transfer channel for transfer of the fastening element strip in a transfer direction, wherein the transfer channel has a separating section, and having a stop element, which has a stop position, in which the stop element projects into the transfer channel and forms a stop for the fastening element in the transfer direction when the fastening element is arranged in the separating section, and a passage position, in which the stop element is arranged outside the transfer channel and allows a movement of the fastening element beyond the separating section in the transfer direction. The separating device preferably has a stop spring, which preloads the stop element toward the stop position.

One advantageous embodiment is characterized in that the separating device has an actuable actuating element, which conveys the stop element from the stop position into the passage position when the actuating element is actuated. The actuating element is preferably actuable manually by a user of the separating device. Likewise as a preference, the actuating element is connected rigidly to the stop element.

One advantageous embodiment is characterized in that the stop element can be moved linearly between the stop position and the passage position.

Another advantageous embodiment is characterized in that the stop element can be pivoted between the stop position and the passage position.

One advantageous embodiment is characterized in that the separating device has a separating element, which has a waiting position, in which the separating element is arranged completely outside the transfer channel, and a separating position, in which the separating element projects into the separating section, wherein a movement of the separating element from the waiting position into the separating position is suitable for moving a fastening element arranged in the separating section relative to the receptacle in a separating direction in order to separate the fastening element from the receptacle. The separating direction preferably slopes relative to the fastening direction. As a particular preference, the separating direction is oriented perpendicularly relative to the fastening direction.

One advantageous embodiment is characterized in that the separating device slopes relative to the transfer direction. The separating direction is preferably oriented perpendicularly relative to the transfer direction.

It is likewise advantageous if the separating device is inserted into a magazine attachment for a driving device for driving fastening elements into an underlying surface, having an add-on part, which has a connecting region for connecting the magazine attachment to the driving device, and having a contact pressure part, which has a contact region for placing the magazine attachment against the underlying surface, wherein the add-on part and the contact pressure part are held against one another so as to be movable along a path of movement in a contact pressure direction, wherein the path of movement is bounded by a normal position and a contact pressure position.

One advantageous embodiment is characterized in that the actuating element projects beyond the contact region toward the underlying surface, with the result that the actuating element is actuated by placing the contact pressure part against the underlying surface.

One advantageous embodiment is characterized in that the contact pressure part has a receptacle for a fastening element, a passage for a driving element, which is mounted on the driving device and with the aid of which a fastening element in the receptacle can be driven into the underlying surface, and a feed channel, connecting the separating section and the receptacle, for feeding a fastening element separated in the separating section to the receptacle.

One advantageous embodiment is characterized in that the contact pressure part has a receptacle for a fastening element and a passage for a driving element, which is mounted on the driving device and with the aid of which a fastening element in the receptacle can be driven into the underlying surface, wherein the magazine attachment has a transfer element, which can be brought by means of a first spring force into engagement with a fastening element or a strip including a fastening element in order to transfer the fastening element into the receptacle in the transfer direction, and a holding element, which can be brought by means of a second spring force into engagement with a fastening element or a strip including a fastening element in order to block a movement of the fastening element counter to the transfer direction.

One advantageous embodiment is characterized in that the magazine attachment has a transfer spring, which loads the transfer element against the fastening element or the strip with the first spring force. The transfer element is preferably formed by the transfer spring.

One advantageous embodiment is characterized in that the magazine attachment has a holding spring, which loads the holding element against the fastening element or the strip with the second spring force. The holding element is preferably formed by the holding spring.

One preferred embodiment is characterized in that the transfer element has one or more transfer projections for engagement in corresponding recesses in the strip and/or for engagement between two fastening elements. In this case, the recesses are preferably each arranged between two fastening elements. According to another embodiment, the recesses are each arranged at the height of a fastening element, in particular the longitudinal axis thereof. The transfer element is preferably mounted so as to be pivotable about a first pivoting axis.

A particularly preferred embodiment is characterized in that the transfer projection has, on the side thereof facing away from the receptacle, a first ramp which, in the case of a force acting on the transfer element from the fastening element or the strip in the transfer direction, brings about a movement of the transfer element transversely to the transfer direction.

One preferred embodiment is characterized in that the holding element has one or more holding projections for engagement in corresponding recesses in the strip and/or for engagement between two fastening elements. The holding element is preferably mounted so as to be pivotable about a second pivoting axis.

A particularly preferred embodiment is characterized in that the holding projection has, on the side thereof facing away from the receptacle, a second ramp which, in the case of a force acting on the transfer element from the fastening element or the strip in the transfer direction, brings about a movement of the holding element transversely to the transfer direction.

One preferred embodiment is characterized in that the transfer element is arranged so as to be movable in the transfer direction.

One preferred embodiment is characterized in that the the holding element is arranged so as to be immovable in the transfer direction.

One preferred embodiment is characterized in that the device has a contact pressure sensor, which actuates the transfer element to transfer the fastening element into the receptacle in the transfer direction when the device is pressed against an underlying surface or when a driving process is complete.

An advantageous fastening system comprises a driving device for driving fastening elements into an underlying surface, preferably a power drill or screwdriver, and a magazine attachment as described, wherein the connecting region is connected to the driving device.

The fastening element preferably comprises a tip and/or a head. The fastening element is preferably provided with a thread and designed as a screw. In alternative embodiments, the fastening element is designed as a nail, bolt or similar.

Preferred illustrative embodiments are explained in greater detail below with reference to the drawings. In the figures:

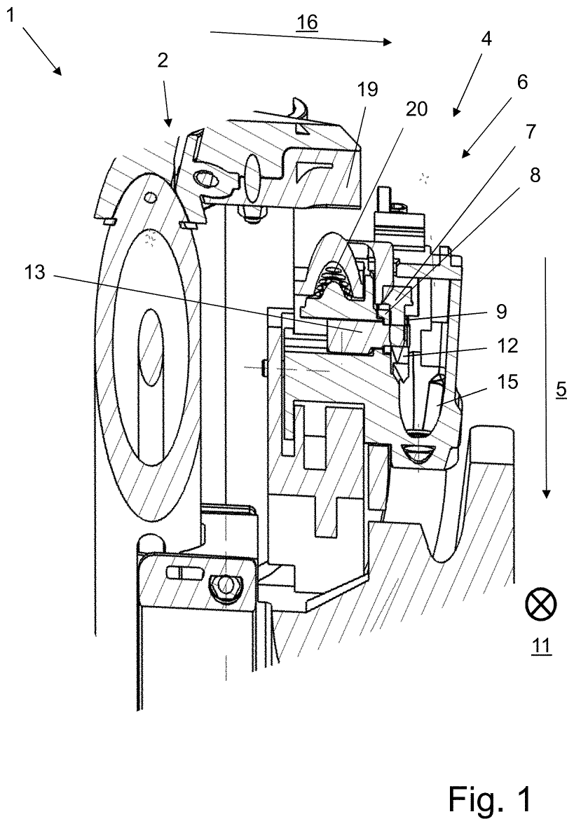

FIG. 1 shows a magazine attachment having a separating device in a cross-sectional view,

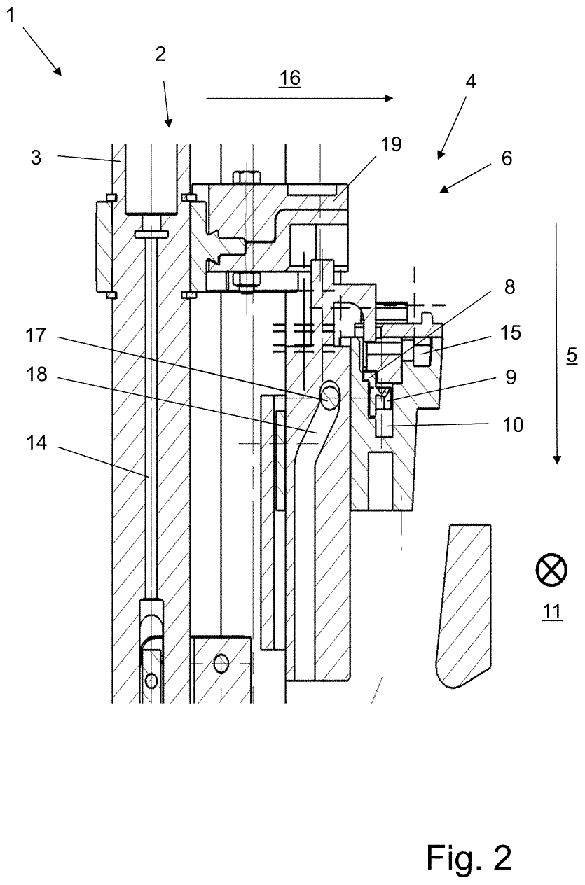

FIG. 2 shows the magazine attachment having the separating device in another cross-sectional view,

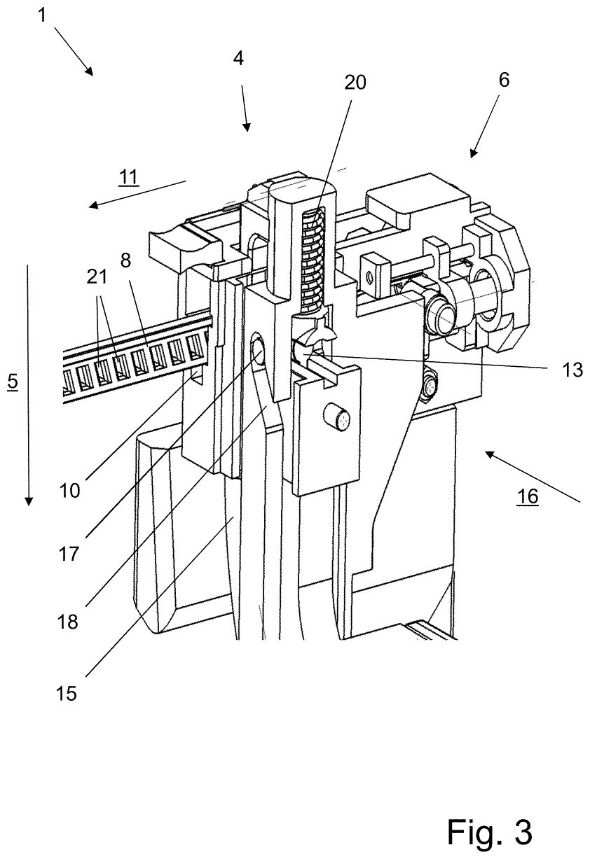

FIG. 3 shows the magazine attachment having the separating device in an oblique view,

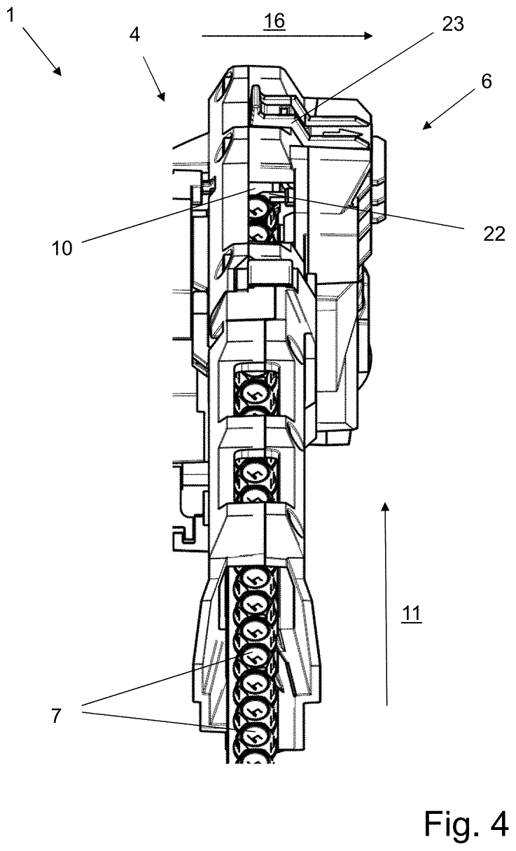

FIG. 4 shows the magazine attachment having the separating device in another oblique view,

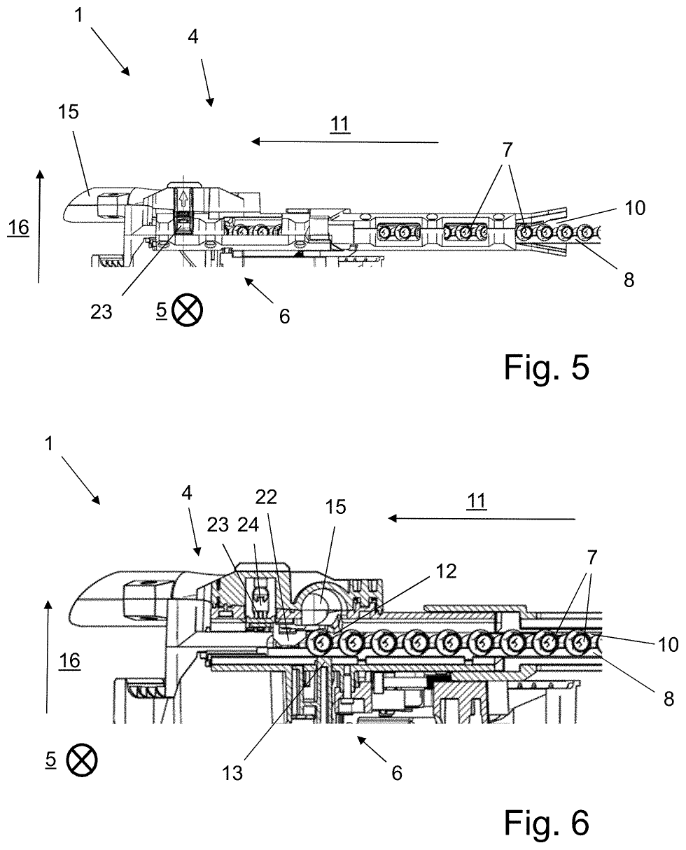

FIG. 5 shows the magazine attachment having the separating device in a plan view,

FIG. 6 shows the magazine attachment having the separating device in another cross-sectional view,

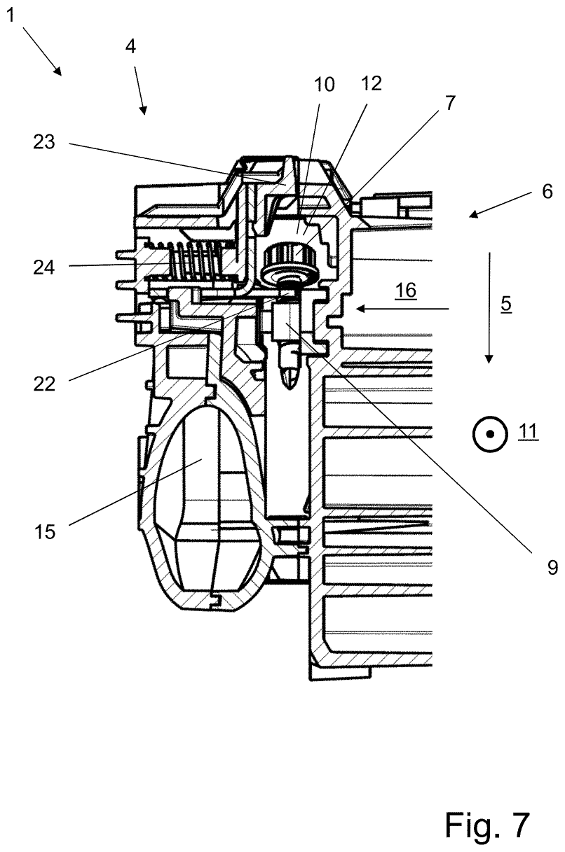

FIG. 7 shows the magazine attachment having the separating device in another cross-sectional view, and

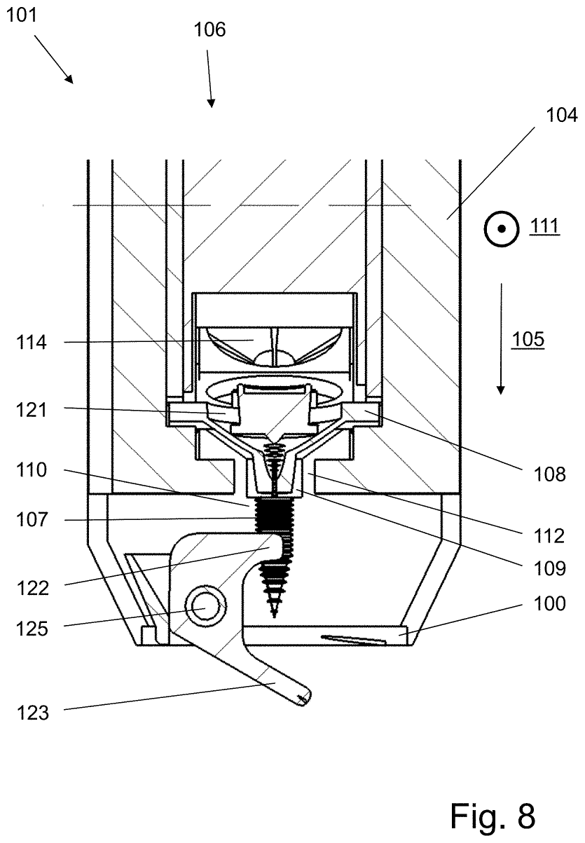

FIG. 8 shows a magazine attachment of another illustrative embodiment in a longitudinally sectioned view.

FIGS. 1, 2, 3, 4, 5, 6 and 7 show a magazine attachment 1 for a driving device (not illustrated) for driving fastening elements, e.g. screws, into an underlying surface. The magazine attachment 1 comprises an add-on part 2, which has a connecting region 3 for connecting the magazine attachment 1 to a driving device, e.g. a screwdriver, and a contact pressure part 4, which has a contact region for placing the magazine attachment 1 against the underlying surface. The add-on part 2 and the contact pressure part 4 are held against one another so as to be movable along a path of movement in a contact pressure direction 5, wherein the path of movement is bounded by a normal position and a contact pressure position.

The magazine attachment 1 comprises a separating device 6 for separating a fastening element 7 from a fastening element strip 8, having a receptacle 9, in which the fastening element 7 is received in such a way that it defines a fastening direction, which is identical with the contact pressure direction 5 and in which the fastening element 7 is provided for the purpose of being driven into an underlying surface. The separating device 6 comprises a transfer channel 10 for transfer of the fastening element strip 8 in a transfer direction 11. The transfer channel 10 has a separating section 12. The separating device 6 furthermore comprises a separating element 13, which has a waiting position (illustrated in FIG. 6), in which the separating element 13 is arranged completely outside the transfer channel 10, and a separating position (illustrated in FIGS. 1, 2 and 3), in which the separating element 13 projects into the separating section 12.

The contact pressure part 4 has a receptacle (not illustrated) for the fastening element 7, a passage 14 for a driving element, e.g. a screw bit, which is mounted on the driving device and with the aid of which the fastening element 7 in the receptacle can be driven into the underlying surface, and a feed channel 15, connecting the separating section 12 and the receptacle, for feeding the fastening element 7 separated in the separating section 12 to the receptacle.

For separation, the fastening element 7 is now first of all transferred through the transfer channel 10 as far as the separating section 12 in the transfer direction 11. Pressing the magazine attachment 1 against the underlying surface brings about a movement of the contact pressure part 4 relative to the add-on part 2 in the contact pressure direction 5. During this process, a control element 17 projecting from the separating element 13 runs in a control groove 18 of the contact pressure part 4, thereby bringing about a movement of the separating element 13 from the waiting position into the separating position. The movement of the control groove 18 relative to the contact pressure part 4 is brought about counter to the force of a counter spring 20 by an actuating element 19 mounted on the add-on part 2.

The movement of the separating element 13 leads to the movement of the fastening element 7 arranged in the separating section 12 relative to the receptacle 9 in a separating direction 16 in order to separate the fastening element 7 from the receptacle 9. For this purpose, the separating element 13 is moved through an opening 21 in the fastening element strip 8. Here, the separating direction 16 is perpendicular to the contact pressure direction 5, that is to say also perpendicular to the fastening direction, and also perpendicular to the transfer direction 11. Owing to the force of gravity, the separated fastening element 7 then falls through the feed channel 15, which is designed as a downtube for example, as far as the receptacle, from which it is driven into the underlying surface.

The magazine attachment 1 furthermore comprises a stop element 22, which has a stop position (illustrated in FIGS. 4, 6 and 7), in which the stop element 22 projects into the transfer channel 10 and forms a stop for the fastening element 7 in the transfer direction 11 when the fastening element 7 is arranged in the separating section, and a passage position, in which the stop element 22 is arranged outside the transfer channel 10 and allows a movement of the fastening element 7 beyond the separating section 12 in the transfer direction 10. In this case, the stop element 22 can be moved linearly between the stop position and the passage position. By virtue of the fact that each fastening element 7 rests against the stop element 22 after transfer into the separating section 13, precise positioning of the fastening element 7 is ensured, and therefore susceptibility to faults in the separating process is reduced.

The separating device 6 has an actuating element 23 which can be actuated manually by the user of the separating device 6 and which conveys the stop element 22 from the stop position into the passage position when the actuating element 23 is actuated. The actuating element 23 is connected rigidly to the stop element 22 and is preloaded toward the stop position, together with the stop element 22, by a stop spring 24. In order to remove the fastening element strip 8 from the magazine attachment 1 with fastening elements 7 that have not yet been separated, the stop element 22 is moved from the stop position into the passage position, counter to a spring force of the stop spring 24, with the aid of the actuating element 23, and the fastening element strip 8 is pulled out of the transfer channel 10 in the transfer direction 11. When the actuating element 23 is released again, the stop element 22 is conveyed back into the stop position by the stop spring 24.

FIG. 8 shows a magazine attachment 101 for a driving device (not illustrated) for driving fastening elements 107, in the illustrative embodiment under consideration screws, into an underlying surface. The magazine attachment 101 comprises an add-on part (not illustrated), which has a connecting region for connecting the magazine attachment 101 to a driving device, in the example under consideration a screwdriver, and a contact pressure part 104, which has a contact region 100 for placing the magazine attachment 101 against the underlying surface. The add-on part and the contact pressure part 104 are held against one another so as to be movable along a path of movement in a contact pressure direction 105, wherein the path of movement is bounded by a normal position and a contact pressure position. The contact pressure part 104 has a passage 114 for a driving element mounted on the driving device, in the example under consideration a screw bit, with the aid of which the fastening element 107 can be driven into the underlying surface.

The magazine attachment 101 comprises a fastening device 106 for separating the fastening element 107 from a fastening element strip 108, having a receptacle 109, in which the fastening element 107 is received in such a way that it defines a fastening direction, which is identical with the contact pressure direction 105 and in which the fastening element 107 is provided for the purpose of being driven into an underlying surface. The separating device 106 comprises a transfer channel 110 for transfer of the fastening element strip 108 in a transfer direction 111. The transfer channel 110 has a separating section 112. A screw bit (not shown) of the driving device forms a separating element, which has a waiting position (illustrated in FIG. 8), in which it is arranged completely outside the transfer channel 110, and a separating position, in which it projects into the separating section 112.

For separation, the fastening element 107 is first of all transferred through the transfer channel 110 into the separating section 112 in the transfer direction 111. Pressing the magazine attachment 101 against the underlying surface brings about a movement of the contact pressure part 104 relative to the add-on part in the contact pressure direction 105.

During this process, the driving device is moved with the add-on part toward the underlying surface, with the result that the separating element designed as a screw bit is moved from the waiting position into the separating position.

This movement leads to the movement of the fastening element 107 arranged in the separating section 112 relative to the receptacle 109 in a separating direction that coincides with the contact pressure direction 105 in order to separate the fastening element 107 from the receptacle 109. For this purpose, the separating element is moved through an opening 121 in the fastening element strip 108. Here, the separating direction is perpendicular to the transfer direction 11. The separated fastening element 7 is then driven into the underlying surface.

The magazine attachment 101 furthermore comprises a stop element 122, which has a stop position (illustrated in FIG. 8), in which the stop element 122 projects into the transfer channel 110 and forms a stop for the fastening element 107 in the transfer direction 111 when the fastening element 107 is arranged in the separating section 112, and a passage position, in which the stop element 122 is arranged outside the transfer channel 110 and allows a movement of the fastening element 107 beyond the separating section 112 in the transfer direction 110. In this case, the stop element 122 can be pivoted about a pivoting axis 125 between the stop position and the passage position. In this illustrative embodiment too, precise positioning of the fastening element 107 is ensured and susceptibility to faults in the separating process is reduced.

The separating device 106 has an actuating element 123 which conveys the stop element 122 from the stop position into the passage position when the actuating element 123 is actuated. The actuating element 123 is connected rigidly to the stop element 122 and is preloaded toward the stop position, together with the stop element 122, by a stop spring (not shown). The actuating element 123 projects beyond the contact region 100 of the contact pressure part 104 toward the underlying surface and is actuated when the magazine attachment 101 is placed against the underlying surface. By means of the actuation, the stop element 122 frees the transfer channel 110, thus enabling the fastening element strip 108 to be transferred further and enabling the next fastening element 107 to be positioned in the separating section and driven into the underlying surface. When the magazine attachment 101 is raised from the underlying surface again, the actuating element 123 is released again, and the stop element 122 is conveyed back into the stop position by the stop spring.

The present invention has been illustrated with reference to the example of a method and a device for separating a fastening element from a fastening element strip. However, attention is drawn to the fact that the method according to the invention and the device according to the invention are also suitable for other purposes.

1. A separating device for separating a fastening element from a fastening element strip, comprising a receptacle, in which the fastening element is received, wherein the fastening element defines a fastening direction, in which the fastening element is provided for being driven into an underlying surface; a transfer channel for transfer of the fastening element strip in a transfer direction, wherein the transfer channel has a separating section; and a stop element, which has a stop position, in which the stop element projects into the transfer channel and forms a stop for the fastening element in the transfer direction when the fastening element is arranged in the separating section, and a passage position, in which the stop element is arranged outside the transfer channel and allows a movement of the fastening element beyond the separating section in the transfer direction.

2. The separating device as claimed in claim 1, having a stop spring, which preloads the stop element toward the stop position.

3. The separating device as claimed in claim 1 having an actuable, actuating element, which conveys the stop element from the stop position into the passage position when the actuating element is actuated.

4. The separating device as claimed in claim 3, wherein the actuating element is connected rigidly to the stop element.

5. The separating device as claimed in claim 1, wherein the stop element can be moved linearly between the stop position and the passage position.

6. The separating device as claimed in claim 1, wherein the stop element can be pivoted between the stop position and the passage position.

7. The separating device as claimed in claim 1 having a separating element, which has a waiting position, in which the separating element is arranged completely outside the transfer channel, and a separating position, in which the separating element projects into the separating section, wherein a movement of the separating element from the waiting position into the separating position is suitable for moving a fastening element arranged in the separating section relative to the receptacle in a separating direction to separate the fastening element from the receptacle.

8. The separating device as claimed in claim 7, wherein the separating direction slopes relative to the fastening direction.

9. A magazine attachment for a driving device for driving fastening elements into an underlying surface, having an add-on part, which has a connecting region for connecting the magazine attachment to the driving device, and having a contact pressure part, which has a contact region for placing the magazine attachment against the underlying surface, wherein the add-on part and the contact pressure part are held against one another so as to be movable along a path of movement in a contact pressure direction, wherein the path of movement is bounded by a normal position and a contact pressure position, and wherein the magazine attachment comprises a separating device as claimed in claim 1.

10. The magazine attachment as claimed in claim 9, wherein the separating device comprises a receptacle, in which the fastening element is received. wherein the fastening element defines a fastening direction, in which the fastening element is provided for being driven into an underlying surface: a transfer channel for transfer of the fastening element strip in a transfer direction, wherein the transfer channel has a separating section: a stop element, which has a stop position, in which the stop element projects into the transfer channel and forms a stop for the fastening element in the transfer direction when the fastening element is arranged in the separating section, and a passage position, in which the stop element is arranged outside the transfer channel and allows a movement of the fastening element beyond the separating section in the transfer direction: and, an actuable, actuating element, which conveys the stop element from the stop position into the passage position when the actuating element is actuated, wherein the actuating element projects beyond the contact region toward the underlying surface, with the result that the actuating element is actuated by placing the contact pressure part against the underlying surface.

11. The magazine attachment as claimed in claim 9, wherein the contact pressure part has a receptacle for a fastening element, a passage for a driving element, which is mounted on the driving device and with the aid of which a fastening element in the receptacle can be driven into the underlying surface, and a feed channel, connecting the separating section and the receptacle, for feeding a fastening element separated in the separating section to the receptacle.

12. The magazine attachment as claimed in claim 9, wherein the contact pressure part has a receptacle for a fastening element and a passage for a driving element, which is mounted on the driving device and with the aid of which a fastening element in the receptacle can be driven into the underlying surface, furthermore having a transfer element, which can be brought by a first spring force into engagement with a fastening element or a strip including a fastening element in order to transfer the fastening element into the receptacle in the transfer direction, and a holding element, which can be brought by a second spring force into engagement with a fastening element or a strip including a fastening element to block a movement of the fastening element counter to the transfer direction.

13. The magazine attachment as claimed in claim 12, having a transfer spring, which loads the transfer element against the fastening element or the strip with the first spring force.

14. The magazine attachment as claimed in claim 12 having a holding spring, which loads the holding element against the fastening element or the strip with the second spring force.

15. A fastening system comprising a driving device for driving fastening elements into an underlying surface and a magazine attachment as claimed in claim 9, wherein the connecting region is connected to the driving device.

16. The separating device as claimed in claim 3, having a manually actuable actuating element, which conveys the stop element from the stop position into the passage position when the actuating element is actuated.

17. The magazine attachment as claimed in claim 13, wherein the transfer element is formed by the transfer spring.

18. The magazine attachment as claimed in claim 14, the holding element is formed by the holding spring.

19. The fastening system as claimed in claim 15, wherein the driving device is a power drill or screwdriver.

20. The magazine attachment as claimed in claim 13, having a holding spring, which loads the holding element against the fastening element or the strip with the second spring force.
